(19) United States
(12) Patent Application Publication
(10) Pub. No.: US 2022/0402363 A1
(43) Pub. Date: Dec. 22, 2022

(54) CONTROL METHOD AND SYSTEM OF A FUEL CELL ELECTRIC VEHICLE STACK

(71) Applicant: Ceres Intellectual Property Company Limited, Horsham, West Sussex (GB)

(72) Inventors: Lei Sun, Weifang, Shandong (CN); Chao Yu, Weifang, Shandong (CN); Youpeng Chen, Weifang, Shandong (CN); Gangyi Hu, Weifang, Shandong (CN)

(21) Appl. No.: 17/638,280

(22) PCT Filed: Oct. 9, 2020
(86) PCT No.: PCT/IB2020/059504

§ 371 Date: Feb. 25, 2022

(30) Foreign Application Priority Data
Aug. 30, 2019 (CN) 201910815982.2

(51) Int. Cl. B60L 3/00; B60L 58/30; H01M 8/04537; H01M 8/04664; H01M 8/04746; H01M 8/04955

(52) U.S. Cl. CPC B60L 3/0053; B60L 58/30; H01M 8/04649; H01M 8/04679; H01M 8/04753; H01M 8/04955; H01M 2250/20; B60L 50/70

(57) ABSTRACT

A control method and system of a fuel cell electric vehicle stack. The control method comprises obtaining insulation resistance of the stack, comprising at least two sub-stacks connected in parallel; and disconnecting a sub-stack with insulation failure from a DC bus and then causing the stack to enter a failure mode when it is determined that the insulation resistance of the stack is smaller than a first preset threshold. The stack is determined to have an insulation failure when it is determined that the insulation resistance of the stack is smaller than the first preset threshold. The sub-stack with the insulation failure is located and disconnected the sub-stack with insulation failure from a DC bus, and the stack is then caused to run in a failure mode to perform failure protection, avoid deterioration of the insulation failure and burnout of the stack and improve the safety performance of the stack.

### TECHNICAL FIELD

The present invention relates to the field of control of fuel cell electric vehicle stacks, particularly to a control method and system of a fuel cell electric vehicle stack.

### BACKGROUND ART

A fuel cell electric vehicle is a vehicle that uses the electricity generated by an on-board fuel cell stack as its power. The key to the fuel cell electric vehicle is the fuel cell stack.

However, existing fuel cell electric vehicles do not have a stack-insulation-failure protection function which may cause deterioration of insulation failure and burnout of the stack, and sub-stacks with insulation failure cannot be located, resulting in poor safety performance of the stack and a high risk.

### SUMMARY OF THE INVENTION

The present invention provides a control method and system of a fuel cell electric vehicle stack to address these problems.

A first aspect of the invention provides a control method of a fuel cell electric vehicle stack, comprising steps of:

obtaining insulation resistance of the stack, which comprises at least two sub-stacks connected in parallel; and

disconnecting a sub-stack with insulation failure from a DC bus and then causing the stack to enter a failure mode when it is determined that the insulation resistance of the stack is smaller than a first preset threshold.

Optionally, the step of disconnecting a sub-stack with insulation failure from a DC bus when it is determined that the insulation resistance of the stack is smaller than a first preset threshold comprises:

stopping input of air, fuel gas and water into the stack, disconnecting the stack from vehicle loads and ceasing discharge of the stack when it is determined that the insulation resistance of the stack is smaller than a first preset threshold;

detecting whether each of the sub-stacks has an insulation failure; and controlling the sub-stack with insulation failure to disconnect the DC bus, and the remaining sub-stacks to connect the DC bus.

Optionally, the step of detecting whether each of the sub-stacks has an insulation failure comprises:

obtaining a first insulation resistance of the stack when all of the sub-stacks are connected to the DC bus;

disconnecting one of the sub-stacks from the DC bus and obtaining a second insulation resistance of the stack composed of the sub-stacks connected to the DC bus;

determining from the first insulation resistance and the second insulation resistance whether the disconnected sub-stack has an insulation failure;

disconnecting another sub-stack from the DC bus and obtaining a third insulation resistance of the stack composed of the sub-stacks connected to the DC bus;

redetermining from the second insulation resistance and the third insulation resistance whether the disconnected sub-stack has an insulation failure; and

repeating the above steps until the determination on whether any sub-stack has an insulation failure is completed.

Optionally, the step of detecting whether each of the sub-stacks has an insulation failure comprises:

selecting any one of the sub-stacks as a present sub-stack, controlling the present sub-stack to connect the DC bus and disconnecting the remaining sub-stacks from the DC bus so that the stack is composed of only the present sub-stack, detecting the insulation resistance of the stack, and determining that the present sub-stack has an insulation failure if the insulation resistance of the stack is smaller than a second preset threshold.

Optionally, the failure mode comprises:

obtaining the number of the sub-stacks in normal operation;

calculating the current maximum output power of the stack according to the number of the sub-stacks in normal operation; and

obtaining the required output power of the stack, and adjusting the flow, pressure and temperature of the air, the flow, pressure and temperature of the fuel gas, the flow, pressure and temperature of the water and the output current of the stack according to the current maximum output power of the stack when the required output power of the stack is greater than the current maximum output power of the stack, to ensure that the actual output power of the stack is the same as the current maximum output power of the stack.

Optionally, each of the sub-stacks is connected in series to an electronic power switch, which is used for controlling the connection between the sub-stack connected thereto in series and the DC bus.

Optionally, a first power diode is connected in series between the anode of each of the sub-stacks and the anode of the DC bus, and a second power diode is connected in series between the cathode of each of the sub-stacks and the cathode of the DC bus.

A second aspect of the invention further provides a control system of a fuel cell electric vehicle stack, comprising: an insulation monitor, a stack comprising at least two sub-stacks connected in parallel, and a fuel cell control unit. The insulation monitor is used for obtaining insulation resistance of the stack. The fuel cell control unit is used for disconnecting a sub-stack with insulation failure from a DC bus and then controlling the stack to enter a failure mode when the insulation resistance of the stack is smaller than a first preset threshold.

Optionally, the control system comprises an air control unit, a fuel gas control unit, a water control unit and a stack pre-charge unit. The air control unit is used for providing air for the stack and controlling the flow, pressure and temperature of the air. The fuel gas control unit is used for providing fuel gas for the stack and controlling the flow, pressure and temperature of the fuel gas. The water control unit is used for providing water for the stack and controlling the flow, pressure and temperature of the water. The stack pre-charge unit is used for pre-charging the current output by the stack, outputting the current to a DC voltage converter after completion of the pre-charging process, and controlling the connection between the stack and the vehicle loads.

Here, the fuel cell control unit cuts off the connection between a sub-stack with insulation failure and a DC bus when the insulation resistance of the stack is smaller than a first preset threshold.

The fuel cell control unit controls the air control unit, the fuel gas control unit and the water control unit to stop working and meanwhile controls the stack pre-charge unit to cut off the connection between the stack and the vehicle loads and stops discharge of the stack when the insulation resistance of the stack is smaller than a first preset threshold; and controls a sub-stack to disconnect from the DC bus, and the remaining sub-stacks to connect the DC bus after the fuel cell control unit detects that the sub-stack has an insulation failure.

Optionally, the detection of insulation failure of sub-stacks by the fuel cell control unit includes the following steps that:

the insulation monitor obtains a first insulation resistance of the stack when all of the sub-stacks are connected to the DC bus;

the fuel cell control unit controls disconnection between one of the sub-stacks and the DC bus and the insulation monitor obtains a second insulation resistance of the stack composed of the sub-stacks connected to the DC bus;

the fuel cell control unit determines from the first insulation resistance and the second insulation resistance whether the disconnected sub-stack has an insulation failure;

the fuel cell control unit controls disconnection between another sub-stack and the DC bus and the insulation monitor obtains a third insulation resistance of the stack composed of the sub-stacks connected to the DC bus;

the fuel cell control unit redetermines from the second insulation resistance and the third insulation resistance whether the disconnected sub-stack has an insulation failure; and

the above steps are repeated until the determination on whether any sub-stack has an insulation failure is completed.

Optionally, the detection of insulation failure of sub-stacks by the fuel cell control unit includes the following steps that: the fuel cell control unit selects any one of the sub-stacks as a present sub-stack, controls the present sub-stack to connect the DC bus and cuts off the connection between the remaining sub-stacks and the DC bus so that the stack is composed of only the present sub-stack, detects the insulation resistance of the stack by an insulation monitor and determines that the present sub-stack has an insulation failure if the insulation resistance of the stack is smaller than a second preset threshold.

Optionally, the control system comprises a vehicle controller; and that the fuel cell control unit controls the stack to enter a failure mode comprises the following steps that:

the fuel cell control unit obtains the number of the sub-stacks in normal operation; and calculates the current maximum output power of the stack according to the number of the sub-stacks in normal operation; and

the fuel cell control unit obtains the required output power of the stack from the vehicle controller and adjusts the flow, pressure and temperature of the air entering the stack, the flow, pressure and temperature of the fuel gas entering the stack, the flow, pressure and temperature of the water entering the stack and the output current of the stack according to the current maximum output power of the stack when the required output power of the stack is greater than the current maximum output power of the stack, to ensure that the actual output power of the stack is the same as the current maximum output power of the stack.

Optionally, each of the sub-stacks is connected in series to an electronic power switch, which is used for controlling the connection between the sub-stack connected thereto in series and the DC bus.

Optionally, a first power diode is connected in series between the anode of each of the sub-stacks and the anode of the DC bus, and a second power diode is connected in series between the cathode of each of the sub-stacks and the cathode of the DC bus.

The present invention provides a control method and system of a fuel cell electric vehicle stack. The control method comprises steps of: obtaining insulation resistance of the stack, which comprises at least two sub-stacks connected in parallel; disconnecting a sub-stack with insulation failure from a DC bus and then causing the stack to enter a failure mode when it is determined that the insulation resistance of the stack is smaller than a first preset threshold. It can be seen from the above content that the technical solution provided by the present invention determines that the stack has an insulation failure when it is determined that the insulation resistance of the stack is smaller than a first preset threshold, then locates the sub-stack that has the insulation failure and disconnects the sub-stack with insulation failure from a DC bus, and then causes the stack to run in a failure mode to perform failure protection on the stack, avoid deterioration of the insulation failure and burnout of the stack and improve the safety performance of the stack.

### BRIEF DESCRIPTION OF THE DRAWINGS

The drawings used in the description will be briefly described below. The drawings in the description below are just some embodiments of the present invention.

FIG. 1 is a flow chart of a control method of a fuel cell electric vehicle stack.

FIG. 2 is a flow chart of a method which cuts off the connection between a sub-stack with insulation failure and the DC bus when it is determined that the insulation resistance of the stack is smaller than a first preset threshold.

FIG. 3 is a structural diagram of a control system of a fuel cell electric vehicle stack.

FIG. 4 is a structural diagram of sub-stacks connected in parallel.

### DETAILED DESCRIPTION

Embodiments of the present invention will be described below in conjunction with the drawings in the embodiments of the present invention. The described embodiments are only some, not all of the embodiments of the present invention.

Existing fuel cell electric vehicles do not have the stack-insulation-failure protection function, which may lead to deterioration of insulation failure and burnout of the stack and sub-stacks with insulation failure cannot be located, resulting in poor safety performance of the stack and a high risk.

The present application provides a control method and system of a fuel cell electric vehicle stack. The control method comprises steps of: obtaining insulation resistance of the stack, which comprises at least two sub-stacks connected in parallel; disconnecting a sub-stack with insulation failure from a DC bus and then causing the stack to enter a failure mode when it is determined that the insulation resistance of the stack is smaller than a first preset threshold. It can be seen from the above content that the technical solution provided by the present invention determines that the stack has an insulation failure when it is determined that the insulation resistance of the stack is smaller than a first preset threshold, then locates the sub-stack that has the insulation failure and disconnects the sub-stack with insulation failure from a DC bus, and then causes the stack to run in a failure mode to perform failure protection on the stack, avoid deterioration of the insulation failure and burnout of the stack and improve the safety performance of the stack.

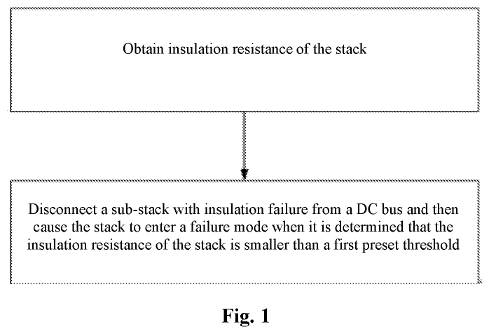

Embodiments of the invention are described in detail with reference to FIG. 1 to FIG. 4.

FIG. 1 is a flow chart of a control method of a fuel cell electric vehicle stack provided by an embodiment of the present invention. The control method of a fuel cell electric vehicle stack, comprises: obtaining insulation resistance of the stack, which comprises at least two sub-stacks connected in parallel; and disconnecting a sub-stack with insulation failure from a DC bus and then causing the stack to enter a failure mode when it is determined that the insulation resistance of the stack is smaller than a first preset threshold.

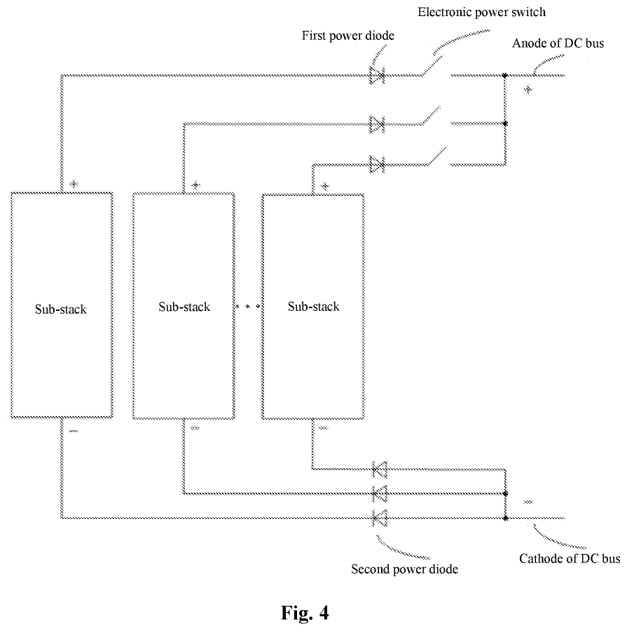

As shown in FIG. 4, the stack comprises at least two sub-stacks connected in parallel, the anode of each of the sub-stacks is connected to the anode of the DC bus and the cathode of each of the sub-stacks is connected to the cathode of the DC bus.

When the stack has an insulation failure, its resistance will inevitably appear abnormal and not be within a normal range, so the first preset threshold in the embodiment of the present invention is used to determine whether the stack has an insulation failure. The embodiment of the present invention does not limit the specific value of the “first preset threshold,” which needs to be calculated and selected according to the actual application.

When the insulation resistance of the stack is smaller than the first preset threshold, it indicates that the stack has an insulation failure, while the stack comprises at least two sub-stacks connected in parallel, so there must be a sub-stack with insulation failure that causes the insulation failure of the stack. Therefore, after it is determined that the stack has an insulation failure, it is necessary to locate the sub-stack with insulation failure and cut off the connection between the sub-stack with insulation failure and the DC bus, that is, to cause the sub-stack with insulation failure to stop working and then cause the stack to enter a failure mode to protect the stack that has an insulation failure.

Each sub-stack is composed of a series of cells connected in series, including air intake and exhaust ports; fuel gas intake and exhaust ports, and power anode and cathode output ports. The cathode of each sub-stack is fed with air and the anode is fed with fuel gas. At certain temperature, an electrochemical reaction occurs through the cells. The oxygen at the cathode turns into cations, which are transferred to the anode through the electrolyte and react with the hydrogen ions and CO at the anode to produce water and CO₂. Electrons form an electrical circuit between the anode and cathode of the sub-stack through loads.

The fuel cell stack may also comprise sub-stacks, reformers, heat exchangers, burners, steam generators and other components, and generates the required electrical power through electrochemical reactions. In other words, the stack works by inputting air, fuel gas and water to generate power and provides the power to a power battery and high-voltage components.

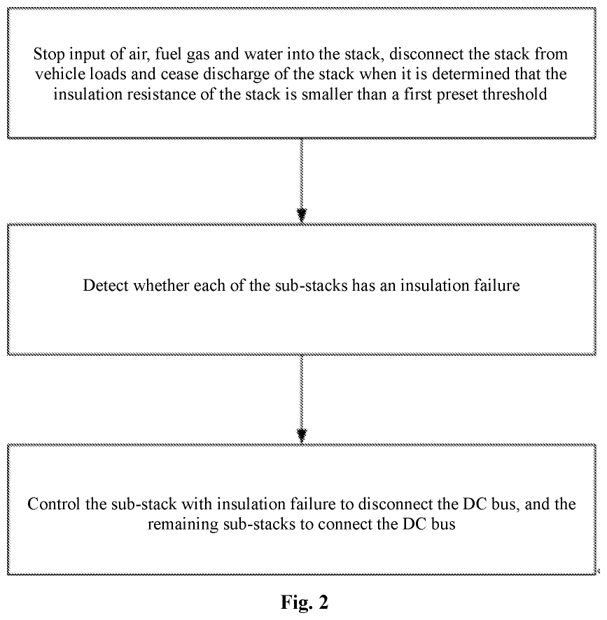

As shown in FIG. 2, in an embodiment of the present invention, the step of disconnecting a sub-stack with insulation failure from a DC bus when it is determined that the insulation resistance of the stack is smaller than a first preset threshold comprises: stopping input of air, fuel gas and water into the stack, disconnecting the stack from vehicle loads and ceasing discharge of the stack when it is determined that the insulation resistance of the stack is smaller than a first preset threshold; detecting whether each of the sub-stacks has an insulation failure; and controlling the sub-stack with insulation failure to disconnect the DC bus, and the remaining sub-stacks to connect the DC bus.

The stack works by inputting air, fuel gas and water to generate power and provides the power to the vehicle loads. When it is determined that the insulation resistance of the stack is smaller than the first preset threshold, it indicates that the stack has an insulation failure. In order to protect the stack in this case, the stack is controlled to stop inputting air, fuel gas and water, the connection between the stack and vehicle loads is cut off and the stack stops discharging and working to avoid discharge of the stack causing performance degradation of the stack or causing short circuit of the stack.

After that, each of the sub-stacks is detected to find the sub-stacks with insulation failure, the sub-stack with insulation failure are controlled to disconnect the DC bus and the remaining sub-stacks are controlled to connect the DC bus to form an operating stack.

In an embodiment of the present invention, the step of detecting whether each of the sub-stacks has an insulation failure comprises: obtaining a first insulation resistance of the stack when all of the sub-stacks are connected to the DC bus; disconnecting one of the sub-stacks from the DC bus and obtaining a second insulation resistance of the stack composed of the sub-stacks connected to the DC bus; determining from the first insulation resistance and the second insulation resistance whether the disconnected sub-stack has an insulation failure; disconnecting another sub-stack from the DC bus and obtaining a third insulation resistance of the stack composed of the sub-stacks connected to the DC bus; redetermining from the second insulation resistance and the third insulation resistance whether the disconnected sub-stack has an insulation failure; and repeating the above steps until the determination on whether any sub-stack has an insulation failure is completed.

Insulation resistance is substantially the resistance of the stack, i.e., the parallel resistance of all the sub-stacks connected to the DC bus. Here, the first insulation resistance is the parallel resistance of all sub-stacks when all the sub-stacks are connected to the DC bus, and the second insulation resistance is the parallel resistance of the remaining sub-stacks when any one of the sub-stacks is disconnected from the DC bus. In this way, from the first insulation resistance and the second insulation resistance, the resistance of the sub-stack disconnected from the DC bus can be determined. The resistance is compared with the second preset threshold. If the resistance is smaller than the second preset threshold, it is determined that the sub-stack disconnected from the DC bus has an insulation failure. By repeating the above steps, the resistance of every sub-stack can be obtained and hence whether any sub-stack has an insulation failure can be determined.

The step of determining from the first insulation resistance and the second insulation resistance whether the disconnected sub-stack has an insulation failure comprises steps of: obtaining the first insulation resistance Rt1, disconnecting any one of the sub-stacks from the DC bus; obtaining the second insulation resistance Rt2.

According to the formula R1=Rt1*Rt2/(Rt2−Rt1), calculating the resistance of the sub-stack disconnected from the DC bus, where R1 is the resistance of the disconnected sub-stack; and comparing the resistance R1 of the sub-stack with the second preset threshold and determining that the sub-stack disconnected from the DC bus has an insulation failure if the resistance is smaller than the second preset threshold.

A first equation:

1/R1+1/R2+ . . . 1/Rn=1/Rt1;

and a second equation:

1/R2+1/R2+ . . . 1/Rn=1/Rt2;

are established according to the calculation formula for parallel resistance; where Rt1 is the first insulation resistance, Rt2 is the second insulation resistance and R1 to Rn are resistances of the sub-stacks respectively;

The first equation minus the second equation obtains a third equation. The third equation is:

1/R1=1/Rt1−1/Rt2.

From the third equation, the calculation formula of sub-stack resistance can be obtained:

R1=Rt1*Rt2/(Rt2−Rt1).

In other words, the resistance of each sub-stack is calculated according to formula Ri=Rtᵢ*Rtᵢ₊₁/(Rtᵢ₊₁−Rtᵢ), where Ri is the resistance of the i-th sub-stack, Rtᵢ is the parallel resistance of i sub-stacks connected to the DC bus, Rtᵢ₊₁ is the parallel resistance of the i−1 remaining sub-stacks connected to the DC bus except the i-th sub-stack, 1≤i≤n−1. When the insulation resistance of the n−1-th sub-stack is calculated, as only the n-th sub-stack is connected to the DC bus when the n−1-th stack is disconnected, the resistance of the n-th sub-stack is equal to the insulation resistance Rtₙ of the stack and can be obtained directly.

The step of redetermining from the second insulation resistance and the third insulation resistance whether the disconnected sub-stack has an insulation failure comprises steps of disconnecting another sub-stack from the DC bus and obtaining a third insulation resistance RT3 of the stack composed of the sub-stacks connected to the DC bus; according to the formula R2=Rt2*Rt3/(Rt3−Rt2), calculating the resistance R2 of the sub-stack disconnected from the DC bus; and comparing the resistance R2 with the second preset threshold and determining that the sub-stack disconnected from the DC bus has an insulation failure if the resistance is smaller than the second preset threshold.

By repeating the above steps, the resistance of every remaining sub-stack can be obtained and hence whether any sub-stack has an insulation failure can be determined.

The embodiment of the present application does not limit the specific value of the “second preset threshold,” which needs to be calculated and selected according to the actual application.

In an embodiment of the present application, the step of detecting whether each of the sub-stacks has an insulation failure comprises: selecting any one of the sub-stacks as a present sub-stack, controlling the present sub-stack to connect the DC bus and disconnecting the remaining sub-stacks from the DC bus so that the stack is composed of only the present sub-stack, detecting the insulation resistance of the stack, and determining that the present sub-stack has an insulation failure if the insulation resistance of the stack is smaller than a second preset threshold; the second preset threshold is used to determine whether an individual sub-stack has an insulation failure, and the embodiment of the present application does not limit the specific value of the “second preset threshold,” which needs to be calculated and selected according to the actual application.

In an embodiment of the present application, the failure mode comprises: obtaining the number of the sub-stacks in normal operation; calculating the current maximum output power of the stack according to the number of the sub-stacks in normal operation; and obtaining the required output power of the stack, and adjusting the flow, pressure and temperature of the air, the flow, pressure and temperature of the fuel gas, the flow, pressure and temperature of the water and the output current of the stack according to the current maximum output power of the stack when the required output power of the stack is greater than the current maximum output power of the stack, to ensure that the actual output power of the stack is the same as the current maximum output power of the stack.

In a failure mode, when the required output power of the stack is greater than the current maximum output power of the stack, in order to ensure that the actual output power of the stack will not exceed the current maximum output power of the stack to match the required output power of the stack, the stack will use the current maximum output power of the stack to match the required output power of the stack, thereby making the actual output power of the stack equal to the current maximum output power of the stack and adjusting the flow, pressure and temperature of the air, the flow, pressure and temperature of the fuel gas, the flow, pressure and temperature of the water and the output current of the stack according to the current maximum output power of the stack to ensure the actual output power of the stack is the same as the current maximum output power of the stack. Here, the water is deionized water.

In a failure mode, when the required output power of the stack is not greater than the current maximum output power of the stack, the flow, pressure and temperature of the air; the flow, pressure and temperature of the fuel gas; the flow, pressure and temperature of the water; and the output current of the stack are adjusted according to the required maximum output power of the stack to ensure the actual output power of the stack is the same as the required output power of the stack.

In an embodiment of the present application, as shown in FIG. 4, each of the sub-stacks is connected in series to an electronic power switch, which is used for controlling the connection between the sub-stack connected thereto in series and the DC bus.

The electronic power switch can be connected in series between the anode of each of the sub-stacks and the anode of the DC bus, or can be connected in series between the cathode of each of the sub-stacks and the cathode of the DC bus. The electronic power switch is used for controlling the connection and disconnection between the sub-stacks and the DC bus to control whether the sub-stacks work or not, and to specifically control whether current of the sub-stacks is output or not.

The electronic power switch can be IGBT, MOS tube, silicon carbide tube, etc.

In an embodiment of the present application, as shown in FIG. 4, a first power diode is connected in series between the anode of each of the sub-stacks and the anode of the DC bus, and a second power diode is connected in series between the cathode of each of the sub-stacks and the cathode of the DC bus. The anode of the sub-stack is connected to the anode of the first power diode, the cathode of the first power diode is connected to the anode of the DC bus, the cathode of the sub-stack is connected to the cathode of the second power diode and the anode of the second power diode is connected to the cathode of the DC bus.

If no power diodes isolate the anodes and cathodes of the sub-stacks, there will be a voltage difference between the sub-stacks and the sub-stacks with a higher voltage will charge the sub-stacks with a lower voltage, thereby causing internal damage of the stack. By connecting a power diode in series between the anode of each of the sub-stacks and the anode of the DC bus and connecting a power diode in series between the cathode of each of the sub-stacks and the cathode of the DC bus, the sub-stacks with a higher voltage can be prevented from charging the sub-stacks with a lower voltage and the mutual impacts among different sub-stacks due to voltage difference can be avoided, thereby protecting the stack and lengthening the life of the stack.

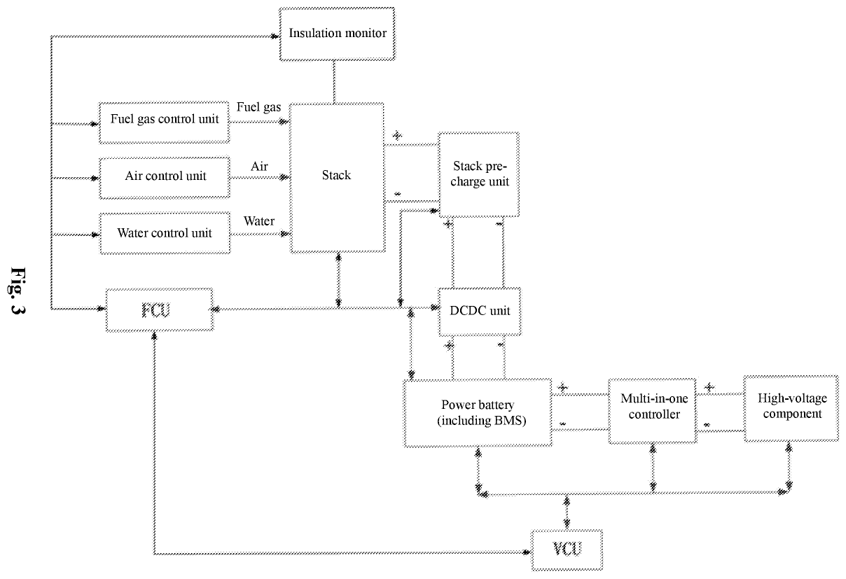

FIG. 3 shows an embodiment of the present application provides a control system of a fuel cell electric vehicle stack, comprising: an insulation monitor, a stack comprising at least two sub-stacks connected in parallel, and a fuel cell control unit (FCU). The insulation monitor is used for obtaining insulation resistance of the stack. The fuel cell control unit is used for disconnecting a sub-stack with insulation failure from a DC bus and then controlling the stack to enter a failure mode when the insulation resistance of the stack is smaller than a first preset threshold.

As shown in FIG. 4, the stack comprises at least two sub-stacks connected in parallel, the anode of each of the sub-stacks is connected to the anode of the DC bus and the cathode of each of the sub-stacks is connected to the cathode of the DC bus.

When the stack has an insulation failure, its resistance will inevitably appear abnormal and not be within a normal range, so the first preset threshold in the embodiment of the present application is used to determine whether the stack has an insulation failure. The embodiment of the present application does not limit the specific value of the “first preset threshold,” which needs to be calculated and selected according to the actual application.

In this embodiment, when the insulation resistance of the stack is smaller than the first preset threshold, it indicates that the stack has an insulation failure, while the stack comprises at least two sub-stacks connected in parallel, so there must be a sub-stack with insulation failure that causes the insulation failure of the stack. Therefore, after it is determined that the stack has an insulation failure, it is necessary to locate the sub-stack with insulation failure and cut off the connection between the sub-stack with insulation failure and the DC bus, that is, to cause the sub-stack with insulation failure to stop working and then cause the stack to enter a failure mode to protect the stack that has an insulation failure.

Each sub-stack is composed of a series of cells connected in series, including air intake and exhaust ports, fuel gas intake and exhaust ports, and power anode and cathode output ports. The cathode of each sub-stack is fed with air and the anode is fed with fuel gas. At certain temperature, an electrochemical reaction occurs through the cells. The oxygen at the cathode turns into cations, which are transferred to the anode through the electrolyte and react with the hydrogen ions and CO at the anode to produce water and CO₂. Electrons form an electrical circuit between the anode and cathode of the sub-stack through loads.

The fuel cell stack may also comprise sub-stacks, reformers, heat exchangers, burners, steam generators and other components and generates the required electrical power through electrochemical reactions. In other words, the stack works by inputting air, fuel gas and water to generate power and provides the power to a power battery and high-voltage components.

In an embodiment of the present application, the insulation monitor is arranged inside a stack pre-charge unit.

It should be noted that the detection principles of the insulation monitor for monitoring insulation resistance are the low-frequency signal injection method or the unbalanced bridge method.

The principle of the low-frequency signal injection method is as follows:

A known excitation signal is given, response signals of the test system are tested and the tested object is calculated according to the difference of the response signals. Excitation pulses are generated inside the insulation detector and pulsate positively and negatively between the high-voltage system and the car body, thereby forming a response signal of positive and negative pulsation. When the insulation resistance of the tested object is different, the response signal and the tested object show a certain mathematical relationship, so that the insulation resistance of the tested object, i.e., the insulation resistance of the stack, can be calculated.

The principle of unbalanced bridge method is as follows:

A series of resistances are accessed between the DC bus and the chassis, the size of the accessed resistance is switched through an electronic switch or a relay, the partial voltage of the positive and negative DC buses at the accessed resistance is measured under different accessed resistances and the insulation resistance of the positive and negative DC buses to the ground is solved according to the equations. The insulation resistance of the positive and negative DC buses to the ground is the insulation resistance of the tested stack.

FIG. 3 shows an embodiment of the present application in which the control system comprises an air control unit, a fuel gas control unit, a water control unit and a stack pre-charge unit. The air control unit is used for providing air for the stack and controlling the flow, pressure and temperature of the air. The fuel gas control unit is used for providing fuel gas for the stack and controlling the flow, pressure and temperature of the fuel gas. The water control unit is used for providing water for the stack and controlling the flow, pressure and temperature of the water. The stack pre-charge unit is used for pre-charging the current output by the stack, outputting the current to a DC voltage converter (DCDC unit) after completion of the pre-charging process, and controlling the connection between the stack and the vehicle loads.

Here, the fuel cell control unit cuts off the connection between a sub-stack with insulation failure and a DC bus when the insulation resistance of the stack is smaller than a first preset threshold.

The fuel cell control unit controls the air control unit, the fuel gas control unit and the water control unit to stop working and meanwhile controls the stack pre-charge unit to cut off the connection between the stack and the vehicle loads and stops discharge of the stack when the insulation resistance of the stack is smaller than a first preset threshold. The fuel cell control unit also controls a sub-stack to disconnect from the DC bus when the fuel cell control unit detects that the sub-stack has an insulation failure, and controls the remaining sub-stacks to connect the DC bus.

The fuel cell control unit is further used to control the pre-charging process of the stack pre-charge unit, communicate with the DCDC unit and control the input current of the DCDC unit. Here, the input current of the DCDC unit is the current that the stack pre-charge unit outputs to the DCDC unit. By controlling the input current of the DCDC unit, the output current of the stack can be controlled.

The fuel cell control unit controls the stack to work and generate power by inputting air, fuel gas and water through the air control unit, the fuel gas control unit and the water control unit and controls the stack to pre-charge the generated power through the stack pre-charge unit. After completion of the pre-charging process the fuel cell control unit outputs the power to the DCDC unit and supplies the power to the vehicle loads for use. When it is determined that the insulation resistance of the stack is smaller than the first preset threshold, it indicates that the stack has an insulation failure. In order to protect the stack in this case, the fuel cell control unit controls the air control unit, the fuel gas control unit and the water control unit to stop working and cuts off the connection between the stack and the vehicle loads through the stack pre-charge unit and the stack stops discharging and working to avoid discharge of the stack causing performance degradation of the stack or causing short circuit of the stack.

After that, each of the sub-stacks is detected to find the sub-stacks with insulation failure, the sub-stack with insulation failure is disconnected from the DC bus and the remaining sub-stacks are controlled to connect the DC bus to form an operating stack.

In an embodiment of the present application, the stack pre-charge unit comprises a main positive relay, a pre-charge relay and a main negative relay, completes the pre-charging process between the stack and the DCDC unit and meanwhile may control the connection between the stack and the vehicle loads by controlling the main relay.

In an embodiment of the present application, the detection of insulation failure of sub-stacks by the fuel cell control unit includes the following steps that: the insulation monitor obtains a first insulation resistance of the stack when all of the sub-stacks are connected to the DC bus; the fuel cell control unit controls disconnection between one of the sub-stacks and the DC bus and the insulation monitor obtains a second insulation resistance of the stack composed of the sub-stacks connected to the DC bus; the fuel cell control unit determines from the first insulation resistance and the second insulation resistance whether the disconnected sub-stack has an insulation failure; the fuel cell control unit controls disconnection between another sub-stack and the DC bus and the insulation monitor obtains a third insulation resistance of the stack composed of the sub-stacks connected to the DC bus; the fuel cell control unit redetermines from the second insulation resistance and the third insulation resistance whether the disconnected sub-stack has an insulation failure; and the above steps are repeated until the determination on whether any sub-stack has an insulation failure is completed.

Insulation resistance is substantially the resistance of the stack, i.e., the parallel resistance of all the sub-stacks connected to the DC bus. Here, the first insulation resistance is the parallel resistance of all sub-stacks when all the sub-stacks are connected to the DC bus, and the second insulation resistance is the parallel resistance of the remaining sub-stacks when any one of the sub-stacks is disconnected from the DC bus. In this way, from the difference between the first insulation resistance and the second insulation resistance, the resistance of the sub-stack disconnected from the DC bus can be determined. The resistance is compared with the second preset threshold. If the resistance is smaller than the second preset threshold, it is determined that the sub-stack disconnected from the DC bus has an insulation failure. By repeating the above steps, the resistance of every sub-stack can be obtained and hence whether any sub-stack has an insulation failure can be determined.

The fuel cell control unit determines from the first insulation resistance and the second insulation resistance whether the disconnected sub-stack has an insulation failure. The fuel cell control unit obtains the first insulation resistance Rt1, controls any one of the sub-stacks to disconnect the DC bus, obtains the second insulation resistance Rt2, and calculates the resistance of the sub-stack disconnected from the DC bus according to the formula R1=Rt1*Rt2/(Rt2−Rt1), where R1 is the resistance of the disconnected sub-stack. The fuel cell control unit compares the resistance R1 of the sub-stack with the second preset threshold and determines that the sub-stack disconnected from the DC bus has an insulation failure if the resistance is smaller than the second preset threshold.

A first equation:

1/R1+1/R2+ . . . 1/Rn=1/Rt1

and a second equation:

1/R2+1/R2+ . . . 1/Rn=1/Rt2

are established according to the calculation formula of parallel resistance, where Rt1 is the first insulation resistance, Rt2 is the second insulation resistance and R1 to Rn are resistances of the sub-stacks respectively.

The first equation minus the second equation obtains a third equation. The third equation is:

1/R1=1/Rt1−1/Rt2.

From the third equation, R1=Rt1*Rt2/(Rt2−Rt1) can be obtained.

The resistance of each sub-stack is calculated according to formula

Ri=Rtᵢ*Rtᵢ₊₁−Rtᵢ),

where Ri is the resistance of the i-th sub-stack, Rtᵢ is the parallel resistance of i sub-stacks connected to the DC bus, Rtᵢ₊₁ is the parallel resistance of the remaining i−1 sub-stacks connected to the DC bus except the i-th sub-stack, 1≤i≤n−1. When the insulation resistance of the n-I-th sub-stack is calculated, as only the n—th sub-stack is connected to the DC bus when the n-I-th stack is disconnected, the resistance of the n-th sub-stack is equal to the insulation resistance Rtₙ of the stack and can be obtained directly.

The fuel cell control unit redetermines from the second insulation resistance and the third insulation resistance whether the disconnected sub-stack has an insulation failure. The fuel cell control unit controls another sub-stack to disconnect the DC bus and obtains a third insulation resistance RT3 of the stack composed of the sub-stacks connected to the DC bus. The fuel cell control unit calculates the resistance R2 of the sub-stack disconnected from the DC bus according to the formula

R2=Rt2*Rt3/(Rt3−Rt2)

and compares the resistance R2 with the second preset threshold and determines that the sub-stack disconnected from the DC bus has an insulation failure if the resistance is smaller than the second preset threshold.

By repeating the above steps, the fuel cell control unit can obtain the resistance of every remaining sub-stack and determine whether any sub-stack has an insulation failure.

The embodiment of the present application does not limit the specific value of the “second preset threshold,” which needs to be calculated and selected according to the actual application.

In an embodiment of the present application, the detection of insulation failure of sub-stacks by the fuel cell control unit includes the following steps: the fuel cell control unit selects any one of the sub-stacks as a present sub-stack, controls the present sub-stack to connect the DC bus and cuts off the connection between the remaining sub-stacks and the DC bus so that the stack is composed of only the present sub-stack, detects the insulation resistance of the stack by an insulation monitor and determines that the present sub-stack has an insulation failure if the insulation resistance of the stack is smaller than a second preset threshold. The second preset threshold is used to determine whether an individual sub-stack has an insulation failure. The embodiment of the present application does not limit the specific value of the “second preset threshold,”

In an embodiment of the present application, the control system comprises a vehicle control unit (VCU), and the fuel cell control unit controls the stack to enter a failure mode. The fuel cell control unit obtains the number of the sub-stacks in normal operation and calculates the current maximum output power of the stack according to the number of the sub-stacks in normal operation. The fuel cell control unit obtains the required output power of the stack, and adjusts the flow, pressure and temperature of the air entering the stack, the flow, pressure and temperature of the fuel gas entering the stack, the flow, pressure and temperature of the water entering the stack and the output current of the stack according to the current maximum output power of the stack when the required output power of the stack is greater than the current maximum output power of the stack, to ensure that the actual output power of the stack is the same as the current maximum output power of the stack.

The vehicle controller is used to control the power output of the vehicle and the interaction with the fuel cell control unit and control the stack in different working states.

In a failure mode, when the required output power of the stack is greater than the current maximum output power of the stack, in order to ensure that the actual output power of the stack will not exceed the current maximum output power of the stack to match the required output power of the stack, the stack will use the current maximum output power of the stack to match the required output power of the stack, thereby making the actual output power of the stack equal to the current maximum output power of the stack and adjusting the flow, pressure and temperature of the air, the flow, pressure and temperature of the fuel gas, the flow, pressure and temperature of the water and the output current of the stack according to the current maximum output power of the stack to ensure the actual output power of the stack is the same as the current maximum output power of the stack.

In a failure mode, the fuel cell control unit obtains the required output power of the stack from the vehicle controller. When the required output power of the stack is not greater than the current maximum output power of the stack, the fuel cell control unit adjusts the flow, pressure and temperature of the air entering the stack, the flow, pressure and temperature of the fuel gas entering the stack, the flow, pressure and temperature of the water entering the stack and the output current of the stack according to the required output power of the stack to ensure the actual output power of the stack is the same as the required output power of the stack.

As shown in FIG. 4, each of the sub-stacks is connected in series to an electronic power switch, which is used for controlling the connection between the sub-stack connected The electronic power switch can be connected in series between the anode of each of the sub-stacks and the anode of the DC bus, or can be connected in series between the cathode of each of the sub-stacks and the cathode of the DC bus. The electronic power switch is used for controlling the connection and disconnection between the sub-stacks and the DC bus to control whether the sub-stacks work or not, and to specifically control whether current of the sub-stacks is output or not.

The electronic power switch can be IGBT, MOS tube, silicon carbide tube, etc.

As shown in FIG. 4, a first power diode is connected in series between the anode of each of the sub-stacks and the anode of the DC bus, and a second power diode is connected in series between the cathode of each of the sub-stacks and the cathode of the DC bus. The anode of the sub-stack is connected to the anode of the first power diode, the cathode of the first power diode is connected to the anode of the DC bus, the cathode of the sub-stack is connected to the cathode of the second power diode and the anode of the second power diode is connected to the cathode of the DC bus.

If no power diodes isolate the anodes and cathodes of the sub-stacks, there will be a voltage difference between the sub-stacks and the sub-stacks with a higher voltage will charge the sub-stacks with a lower voltage, thereby causing internal damage of the stack. By connecting a power diode in series between the anode of each of the sub-stacks and the anode of the DC bus and connecting a power diode in series between the cathode of each of the sub-stacks and the cathode of the DC bus, the sub-stacks with a higher voltage can be prevented from charging the sub-stacks with a lower voltage and the mutual impacts among different sub-stacks due to voltage difference can be avoided, thereby protecting the stack and lengthening the life of the stack.

As shown in FIG. 3, the control system comprises a power battery, which comprises a battery management system (BMS), a multi-in-one controller and high-voltage components.

The power battery is connected to the stack in parallel on a DC bus and is used to provide a power supply required by instantaneous power of an electric vehicle. To be specific, the fuel cell control unit controls the pre-charge unit to complete a pre-charging process and causes the power output port of the stack to be connected to the DCDC unit, the battery management system sends the maximum charge and discharge power output parameters of the power battery to the vehicle controller, and the vehicle controller provides power for the high-voltage components of the vehicle according to these parameters and in combination with the maximum output power of the stack presently sent by the fuel cell control unit.

The multi-in-one controller is used to distribute power of the DC bus and comprises a power distribution unit (PDU), a low-voltage output DC voltage converter, an electric steering pump controller and an electric air compressor controller.

The high-voltage components include a motor controller, an electric steering pump, an electric air compressor, an electric air conditioner, an electric defroster, an electric heater and an air blower controller.

The present application provides a control method and system of a fuel cell electric vehicle stack. The control method comprises steps of: obtaining insulation resistance of the stack, which comprises at least two sub-stacks connected in parallel; disconnecting a sub-stack with insulation failure from a DC bus and then causing the stack to enter a failure mode when it is determined that the insulation resistance of the stack is smaller than a first preset threshold. It can be seen from the above content that the technical solution provided by the present invention determines that the stack has an insulation failure when it is determined that the insulation resistance of the stack is smaller than a first preset threshold, then locates the sub-stack that has the insulation failure and disconnects the sub-stack with insulation failure from a DC bus, and then causes the stack to run in a failure mode to perform failure protection on the stack, avoid deterioration of the insulation failure and burnout of the stack and improve the safety performance of the stack.

Various modifications to these embodiments will be apparent. The general principle defined herein can be implemented in other embodiments without departing from the scope of the present invention.

1. A control method of a fuel cell electric vehicle stack which comprises at least two sub-stacks connected in parallel and a DC bus, the method comprising:
obtaining insulation resistance of the stack; and
disconnecting a sub-stack with insulation failure from the DC bus and then causing the stack to enter a failure mode when it is determined that the insulation resistance of the stack is smaller than a first preset threshold.

2. The control method according to claim 1, wherein the step of disconnecting a sub-stack with insulation failure from the DC bus comprises:
stopping input of air, fuel gas, and water into the stack;
disconnecting the stack from vehicle loads; and
ceasing discharge of the stack when it is determined that the insulation resistance of the stack is smaller than the first preset threshold;
detecting whether each of the sub-stacks has an insulation failure; and
controlling the sub-stack with insulation failure to disconnect the DC bus, and the remaining sub-stacks to connect the DC bus.

3. The control method according to claim 2, wherein the stack comprises at least three sub-stacks, and the step of detecting whether each of the sub-stacks has an insulation failure comprises:
obtaining a first insulation resistance of the stack when all of the sub-stacks are connected to the DC bus;
obtaining a second insulation resistance of the stack by disconnecting one of the sub-stacks from the DC bus and obtaining the second insulation resistance of the stack composed of the sub-stacks remaining connected to the DC bus;
determining from the first insulation resistance and the second insulation resistance whether the disconnected sub-stack has an insulation failure;
obtaining a third insulation resistance of the stack by disconnecting another sub-stack from the DC bus and obtaining a third insulation resistance of the stack composed of the sub-stacks remaining connected to the DC bus; and
determining from the second insulation resistance and the third insulation resistance whether the disconnected sub-stack has an insulation failure.

4. The control method according to claim 3, wherein the stack comprises more than three sub-stacks, the method comprising repeating the steps of disconnecting a sub-stack and obtaining an insulation resistance of the stack composed of the sub-stacks remaining connected to the DC bus until the determination on whether any sub-stack has an insulation failure is completed.

5. The control method according to claim 2, wherein the step of detecting whether each of the sub-stacks has an insulation failure comprises:
selecting any one of the sub-stacks as a present sub-stack;
controlling the present sub-stack to connect the DC bus and disconnecting the remaining sub-stacks from the DC bus so that the stack is composed of only the present sub-stack;
detecting the insulation resistance of the stack; and
determining that the present sub-stack has an insulation failure if the insulation resistance of the stack is smaller than a second preset threshold.

6. The control method of claim 5, wherein the stack comprises at least three sub-stacks, the method comprising selecting each sub-stack in turn as the present sub-stack and determining the resistance of the stack composed of only the present sub-stack until the sub-stack with the insulation failure has been detected.

7. The control method according to any preceding claim 1, wherein the failure mode comprises:
obtaining the number of the sub-stacks in normal operation;
calculating the current maximum output power of the stack according to the number of the sub-stacks in normal operation; and
obtaining the required output power of the stack, and adjusting the flow, pressure and temperature of the air, the flow, pressure and temperature of the fuel gas, the flow, pressure and temperature of the water and the output current of the stack according to the current maximum output power of the stack when the required output power of the stack is greater than the current maximum output power of the stack, to ensure that the actual output power of the stack is the same as the current maximum output power of the stack.

8. The control method according to claim 1, wherein each of the sub-stacks is connected in series to an electronic power switch, which is used for controlling the connection between the connected sub-stack and the DC bus.

9. The control method according to claim 1, wherein a first power diode is connected in series between an anode of each of the sub-stacks and an anode of the DC bus, and a second power diode is connected in series between a cathode of each of the sub-stacks and a cathode of the DC bus.

10. A control system for a fuel cell electric vehicle stack, comprising:
an insulation monitor,
a stack comprising at least two sub-stacks connected in parallel, and
a fuel cell control unit; wherein
the insulation monitor is configured to obtain an insulation resistance of the stack; and
the fuel cell control unit is configured to disconnect a sub-stack with insulation failure from a DC bus and then control the stack to enter a failure mode when the insulation resistance of the stack is smaller than a first preset threshold.

11. The control system according to claim 10, wherein the control system further comprises:
an air control unit;
a fuel gas control unit;
a water control unit; and
a stack pre-charge unit;
wherein
the air control unit is configured to provide air for the stack and control the flow, pressure and temperature of the air;
the fuel gas control unit is configured to provide fuel gas for the stack and control the flow, pressure and temperature of the fuel gas;
the water control unit is configured to provide water for the stack and control the flow, pressure and temperature of the water;
the stack pre-charge unit is configured to pre-charge the current output by the stack, output the current to a DC voltage converter after completion of the pre-charging process, and control the connection between the stack and vehicle loads; and
wherein the fuel cell control unit is configured to:
cut off the connection between a sub-stack with insulation failure and a DC bus when the insulation resistance of the stack is smaller than a first preset threshold; and
control the air control unit, the fuel gas control unit, and the water control unit to stop working and at the same time, control the stack pre-charge unit to cut off the connection between the stack and the vehicle loads and stop discharge of the stack when the insulation resistance of the stack is smaller than a first preset threshold; and
control a sub-stack to disconnect from the DC bus, and the remaining sub-stacks to connect the DC bus after the fuel cell control unit detects that the sub-stack has an insulation failure.

12. The control system according to claim 11, wherein:
the insulation monitor is configured to obtain a first insulation resistance of the stack when all of the sub-stacks are connected to the DC bus;
the fuel cell control unit is configured to control disconnection between one of the sub-stacks and the DC bus and the insulation monitor is configured to obtain a second insulation resistance of the stack composed of the sub-stacks connected to the DC bus;
the fuel cell control unit is configured to determine from the first insulation resistance and the second insulation resistance whether the disconnected sub-stack has an insulation failure;
the fuel cell control unit is configured to control disconnection between another sub-stack and the DC bus and the insulation monitor is configured to obtain a third insulation resistance of the stack composed of the sub-stacks connected to the DC bus;
the fuel cell control unit is configured to determine again from the second insulation resistance and the third insulation resistance whether the disconnected sub-stack has an insulation failure; and
the fuel cell control unit and the insulation monitor are configured to repeat the steps until the determination on whether any sub-stack has an insulation failure is completed.

13. The control system according to claim 11, wherein: the fuel cell control unit is configured to select any one of the sub-stacks as a present sub-stack, control the present sub-stack to connect the DC bus and cut off the connection between the remaining sub-stacks and the DC bus so that the stack is composed of only the present sub-stack, and the insulation monitor is configured to detect the insulation resistance of the stack and determine that the present sub-stack has an insulation failure if the insulation resistance of the stack is smaller than a second preset threshold.

14. The control system according to claim 10, wherein the control system comprises a vehicle controller; and that the fuel cell control unit is configured to control the stack to enter a failure mode, wherein:
the fuel cell control unit is configured to obtain the number of the sub-stacks in normal operation; and calculate the current maximum output power of the stack according to the number of the sub-stacks in normal operation; and
the fuel cell control unit is configured to obtain the required output power of the stack from the vehicle controller and adjust the flow, pressure and temperature of the air entering the stack, the flow, pressure and temperature of the fuel gas entering the stack, the flow, pressure and temperature of the water entering the stack, and the output current of the stack according to the current maximum output power of the stack when the required output power of the stack is greater than the current maximum output power of the stack, to ensure that the actual output power of the stack is the same as the current maximum output power of the stack.

15. The control system according to claim 10, wherein each of the sub-stacks is connected in series to an electronic power switch, which is used for controlling the connection between the sub-stack connected thereto in series and the DC bus.

16. The control system according to claim 10, wherein a first power diode is connected in series between the anode of each of the sub-stacks and the anode of the DC bus, and a second power diode is connected in series between the cathode of each of the sub-stacks and the cathode of the DC bus.
